(19) United States
(12) Patent Application Publication
(10) Pub. No.: US 2026/0229526 A1
(43) Pub. Date: Aug. 6, 2026

(54) LITHIUM-ION BATTERY BINDER AND SOLVENT

(71) Applicant: FORD GLOBAL TECHNOLOGIES, LLC, Dearborn, MI (US)

(72) Inventors: Benjamin Jason EMLEY, Canton, MI (US); Cong LIU, Macomb, MI (US); Sarthak VAIDYA, Ann Arbor, MI (US)

(21) Appl. No.: 19/042,971

(22) Filed: Jan. 31, 2025

(51) Int. Cl. H01M 4/62; H01M 4/04; H01M 10/0525

(52) U.S. Cl. CPC H01M 4/622; H01M 4/0404; H01M 10/0525

(57) ABSTRACT

A method for forming an electrode for a lithium-ion battery is presented. The method involves blending a polymer binder, cathode active material particles, and a solvent to create an initial dispersion where the polymer binder remains undissolved. The dispersion is then subjected to wet-jet milling at a pressure and duration sufficient to physically and chemically attach the polymer binder to the surfaces of the cathode active material particles, resulting in a stable dispersion resistant to sedimentation. The stable dispersion is subsequently deposited onto a current collector to form the electrode.

### TECHNICAL FIELD

This disclosure relates to lithium-ion batteries as well as binders and solvents used in lithium-ion batteries.

### BACKGROUND

Current lithium-ion battery manufacturing often utilizes n-methyl pyrrolidone (NMP) as a solvent for processing and coating cathode materials onto aluminum foil, the current collector. NMP is compatible with polyvinylidene fluoride (PVDF), a widely used binder known for its stability within the electrochemical operating window, particularly at the cathode's higher potentials. PVDF's chemical structure requires solvents such as NMP to dissolve and disperse the binder with cathode active materials and conductive additives effectively.

### SUMMARY

A method of forming an electrode for a lithium-ion battery is provided. This method includes blending a polymer binder, cathode active material particles, and a solvent to form an initial dispersion in which the polymer binder is not dissolved, wet-jet milling the initial dispersion at a pressure and duration sufficient to physically and chemically attach the polymer binder onto surfaces of the cathode active material particles, forming a stable dispersion resistant to sedimentation, and depositing the stable dispersion onto a current collector to form an electrode. The polymer binder may be polyvinylidene fluoride. The cathode active material particles may comprise a lithium metal oxide selected from a group consisting of lithium nickel manganese cobalt oxide, lithium nickel cobalt aluminum oxide, lithium cobalt oxide, lithium manganese oxide, and lithium iron phosphate. The solvent may be selected from a group consisting of water, alcohols, ketones, esters, ethers, and mixtures thereof, and may be substantially free of N-methyl pyrrolidone. The wet-jet milling may be conducted at a pressure range from 200 bar to 3,000 bar. The duration of wet-jet milling may be determined such that, after processing, the stable dispersion exhibits no visible sedimentation for at least one week. The polymer binder loading in the final cathode electrode layer may be reduced relative to a cathode electrode layer formed by a process involving dissolution of the polymer binder prior to particle mixing. The method may include controlling the wet-jet milling parameters to achieve a desired level of polymer coverage on the cathode active material particles, thereby minimizing electrochemically inactive regions in the final cathode electrode. The stable dispersion may exhibit steric hindrance between cathode active material particles resulting from polymer binder chains adhered to their surfaces. The method may include drying the deposited cathode electrode layer to remove the solvent and yield an electrode structure suitable for assembly into a lithium-ion battery cell.

A method of forming a lithium-ion battery electrode is provided. This method includes mixing a non-soluble polymer binder, cathode active material particles, and a non-theta solvent to form an initial mixture, wet-jet milling the initial mixture to form a stable dispersion in which the polymer binder adheres to sterically hindered cathode active material particles, and adjusting a parameter of the wet-jet milling to generate a predetermined polymer binder loading and form an electrode. The parameter may be at least one of a pressure, a flow rate, or a milling time. The solvent may be ethyl acetate. The stable dispersion may remain uniform after lithium-ion battery formation. The method may include heating the final electrode structure after drying to increase polymer binder adhesion and mechanical integrity. The cathode active material particles may have a median particle size ranging from 1 μm to 20 μm. The polymer binder may be selected from a group including polyvinylidene fluoride, polyacrylonitrile, carboxymethyl cellulose, polyimide, and styrene-butadiene rubber. The final electrode structure may have increased rate capability due to optimized polymer placement on cathode active material particles. The controlled polymer binder usage may reduce electrolyte decomposition at polymer-rich interfaces.

A lithium-ion battery is provided. This battery includes an anode, a cathode, including a stable dispersion of cathode active material particles with surfaces having physically adhered polymer binder molecules in a non-theta solvent to maintain the binder in an undissolved state, an electrolyte in ionic contact with both the anode and cathode, and a separator between the anode and cathode.

### BRIEF DESCRIPTION OF THE DRAWINGS

FIG. 1 is a comparative graph of coating line speeds for battery cathode electrodes;

FIGS. 2-5 are scanning electron microscope morphologies of active material particles under various conditions;

FIG. 6 shows a schematic cross-section of a lithium-ion battery; and

FIG. 7 is a process flow diagram for forming a lithium-ion battery.

### DETAILED DESCRIPTION

Embodiments are described herein. It is to be understood, however, that the disclosed embodiments are merely examples and other embodiments may take various and alternative forms. The figures are not necessarily to scale. Some features could be exaggerated or minimized to show details of particular components. Therefore, specific structural and functional details disclosed herein are not to be interpreted as limiting, but merely as a representative basis for teaching one skilled in the art.

Various features illustrated and described with reference to any one of the figures may be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Unless explicitly stated otherwise, terminology used in this disclosure should be interpreted broadly and inclusively. Singular terms such as “a,” “an,” and “the” encompass plural referents unless the context dictates otherwise. Similarly, references to percentages, parts, and ratios are understood to be by weight unless otherwise indicated. Ranges include all intermediate values and subranges within their boundaries. For example, a pressure range of 200 bar to 3,000 bar includes specific values such as 500 bar, 1,500 bar, and 2,700 bar. Unless explicitly stated otherwise, all numerical values and ranges in this document are prefixed by the term “about.” This applies even if “about” is not explicitly stated.

The term “dispersion” refers to a mixture of polymer binder, cathode active material particles, and solvent in which the polymer binder remains undissolved. “Stable dispersion” denotes a dispersion that resists sedimentation over an extended period, such as one week or more. The term “wet-jet milling” refers to a high-pressure mechanical process that physically and chemically attaches polymer binders to the surfaces of cathode active material particles.

As used herein, “polymer binder” encompasses a range of polymeric materials capable of physically and chemically adhering to cathode active material particles during wet-jet milling. Examples include, but are not limited to, PVDF, polyacrylonitrile (PAN), carboxymethyl cellulose (CMC), polyimide (PI), and styrene-butadiene rubber (SBR).

The term “cathode active material particles” refers to particles that function as active material in a lithium-ion battery cathode, including lithium metal oxides such as lithium nickel manganese cobalt oxide (NMC), lithium nickel cobalt aluminum oxide (NCA), lithium cobalt oxide (LCO), lithium manganese oxide (LMO), and lithium iron phosphate (LFP). Particle sizes typically range from 1 μm to 20 μm in median diameter.

References to “non-theta solvent” indicate a solvent in which the polymer binder remains undissolved during the blending process. Examples include water, alcohols, ketones, esters, ethers, and mixtures thereof. The solvent serves as a medium for dispersing the particles but does not facilitate polymer dissolution.

The term “steric hindrance” describes the spatial separation between particles in the stable dispersion, caused by polymer chains adhering to particle surfaces. This steric effect maintains particle dispersion within the solvent, preventing agglomeration and sedimentation.

Conventional approaches often rely on dissolving polymer binders in processing solvents before introducing active material particles. This dissolution process inherently lacks precision, leading to uneven distribution of the binder across particle surfaces, formation of polymer-rich regions, and the creation of electrochemically inactive voids. By contrast, the methods disclosed herein involve blending the polymer binder in an undissolved state with cathode active material particles and solvent to form an intentionally unstable dispersion, which is then stabilized through wet-jet milling.

Wet-jet milling achieves stabilization by applying intense shear forces to the dispersion, causing physical and chemical attachment of polymer chains onto the surfaces of cathode active material particles. This attachment not only secures the polymer binder but also creates steric hindrance, so that particles remain uniformly distributed in the solvent and resist sedimentation. The resulting stable dispersion is characterized by increased homogeneity and reduced binder usage, directly addressing the inefficiencies of classical methods.

An advantage of the disclosed method is its flexibility in selecting processing solvents. Unlike conventional approaches, which often depend on specific solvents, such as NMP, to dissolve polymer binders, this method allows the use of a wide range of solvents, including those that are less volatile. Solvent selection primarily focuses on chemical compatibility with the cathode active material and the ability to maintain the polymer binder in an undissolved state during initial dispersion formation.

The pressure and duration of wet-jet milling play a role in determining the extent of polymer attachment to particle surfaces. Pressures ranging from 200 bar to 3,000 bar, coupled with carefully controlled milling durations, enable the fine-tuning of polymer coverage on cathode active material particles. This control minimizes unnecessary polymer presence, maximizing the active surface area available for electrochemical reactions and reducing dead space within the electrode structure.

The disclosed methods also address challenges related to the mechanical integrity of the electrode structure. By maintaining uniform polymer coverage, the resulting electrodes exhibit increased mechanical cohesion, which is particularly beneficial during battery assembly and cycling. Additionally, optional post-processing steps, such as drying and heating the electrode, further increase polymer adhesion and structural stability, contributing to long-term performance and reliability.

The process enables precise engineering of electrode properties, such as polymer loading, particle size distribution, and dispersion stability. These parameters can be adjusted to meet specific performance requirements, such as increased rate capability or reduced electrolyte decomposition at polymer-rich interfaces. For example, optimized polymer placement ensures that cathode active material particles maintain intimate contact with the electrolyte, facilitating efficient lithium-ion transport and reducing internal resistance.

Furthermore, the disclosed methods are compatible with a broad range of cathode active materials, including advanced compositions such as NMC and NCA. These materials, known for their high energy density and cycling stability, benefit from the precise control over polymer coverage and particle dispersion afforded by this process. The methods also contribute to sustainable manufacturing practices by reducing polymer binder usage and enabling the use of environmentally friendly solvents.

The present disclosure encompasses various embodiments and configurations, including methods for fabricating electrodes, optimized wet-jet milling parameters, and electrode structures resulting from the disclosed processes. The described techniques are adaptable to different manufacturing scales, from laboratory settings to industrial production, making them versatile tools for advancing lithium-ion battery technology.

The disclosure is not limited to lithium-ion battery applications and may be extended to other energy storage systems or material processing fields where precise control over polymer-material interactions is desirable. For example, the methods may be adapted for use in supercapacitors, solid-state batteries, or other electrochemical devices requiring uniform material distribution and minimized inactive regions.

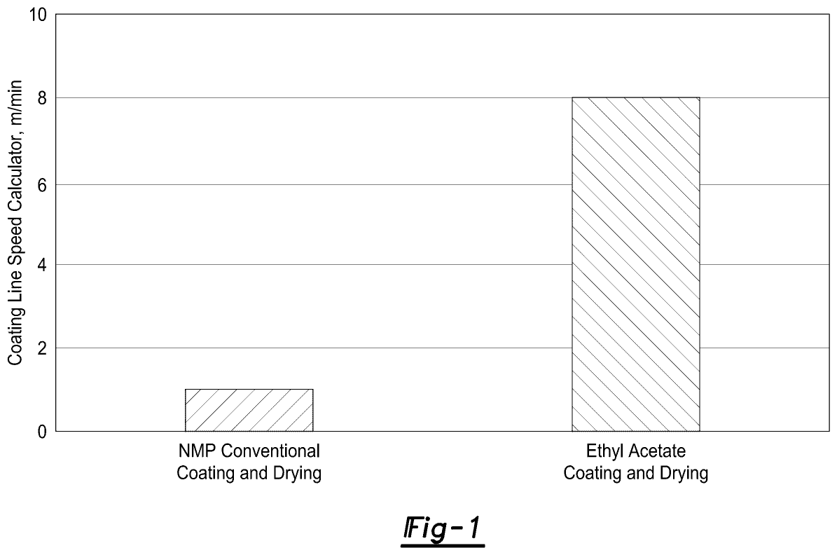

FIG. 1 shows a comparative analysis of coating line speeds for battery cathode electrodes processed via traditional ceramic processing with NMP versus the disclosed dispersion technology utilizing ethyl acetate as the solvent. The graph highlights the disparity between the two approaches, with the conventional NMP-based method achieving a coating line speed of approximately 1 meter per minute, whereas the disclosed method reaches a much faster speed of around 10 meters per minute. This increased performance is attributed to the disclosed dispersion process, which eliminates the need to dissolve the polymer binder in the solvent prior to coating, allowing for greater efficiency and consistency.

The use of ethyl acetate in the disclosed method offers several advantages over NMP. Ethyl acetate has a lower heat of vaporization, reducing the energy required for drying and enabling faster throughput. Moreover, the disclosed process requires only a single-zone drying setup, compared to the conventional three-zone drying necessary for NMP-based coatings, further reducing equipment size and spatial requirements.

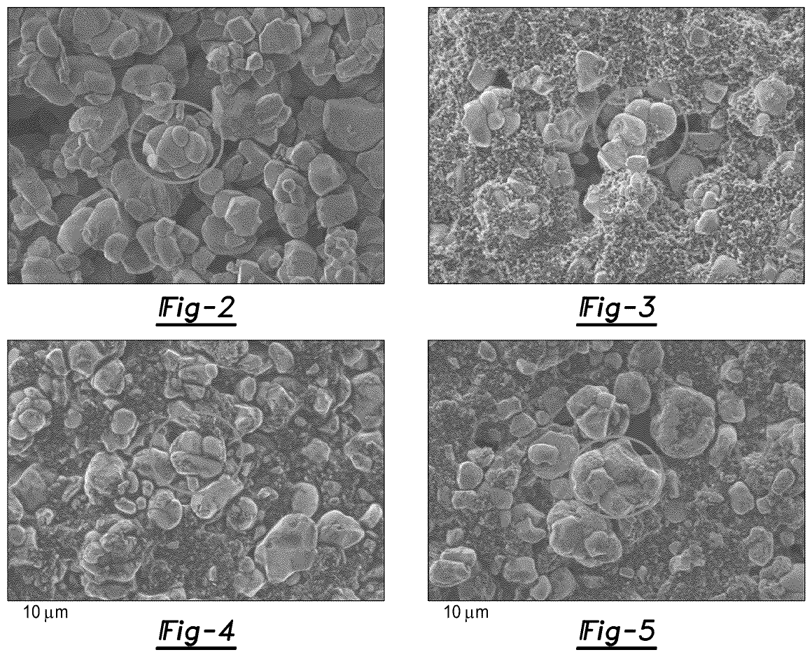

FIGS. 2-5 show scanning electron microscopy (SEM) images of NMC-622 primary particles and dispersions processed under different conditions, illustrating the effect of slurry mixing and wet-jet milling on particle morphology and material distribution. These figures focus on the structural integrity of the circled NMC-622 particles and the arrangement of surrounding carbon black (CB) and polyvinylidene fluoride in various processing scenarios.

FIG. 2 shows the pristine NMC-622 primary particles, which have not undergone any mixing or processing. These particles appear well-defined with no signs of external material coverage, serving as a baseline reference for comparison. The lack of carbon black or PVDF ensures the particle morphology remains unaltered.

In FIG. 3, NMC-622 particles are shown after standard slurry mixing with carbon black and PVDF in NMP. While the primary particles remain intact, their surfaces are covered with an extensive network of PVDF and CB. This excess material may lead to electrochemical inefficiencies by creating inactive regions that reduce the active surface area available for lithium-ion transport. The uneven binder and CB distribution is characteristic of conventional processing methods that rely on pre-dissolving the polymer binder in NMP.

FIG. 4 shows NMC-622 particles subjected to wet-jet milling for a short duration in ethyl acetate. The primary particles retain their structural integrity, demonstrating that the high shear forces applied during milling do not alter the particles. Additionally, the distribution of CB and PVDF is more controlled, with less excess material surrounding the particles compared to the sample in FIG. 3. This suggests that wet-jet milling facilitates better utilization of the binder and conductive additive, increasing particle accessibility.

FIG. 5 shows the results of wet-jet milling with a longer residence time in ethyl acetate. As in FIG. 4, the primary particles remain intact, verifying that extended processing durations do not compromise particle morphology. The distribution of PVDF and CB appears even more optimized, with minimal excess material observed around the particles. This uniform binder and additive placement increase the electrochemical efficiency of the electrode by reducing inactive regions and ensuring better contact between active material particles and the electrolyte.

FIGS. 2-5 highlight the advantages of wet-jet milling in ethyl acetate over traditional slurry mixing in NMP. The wet-jet milling process preserves particle integrity while achieving uniform binder distribution, minimizing the formation of electrochemically inactive regions.

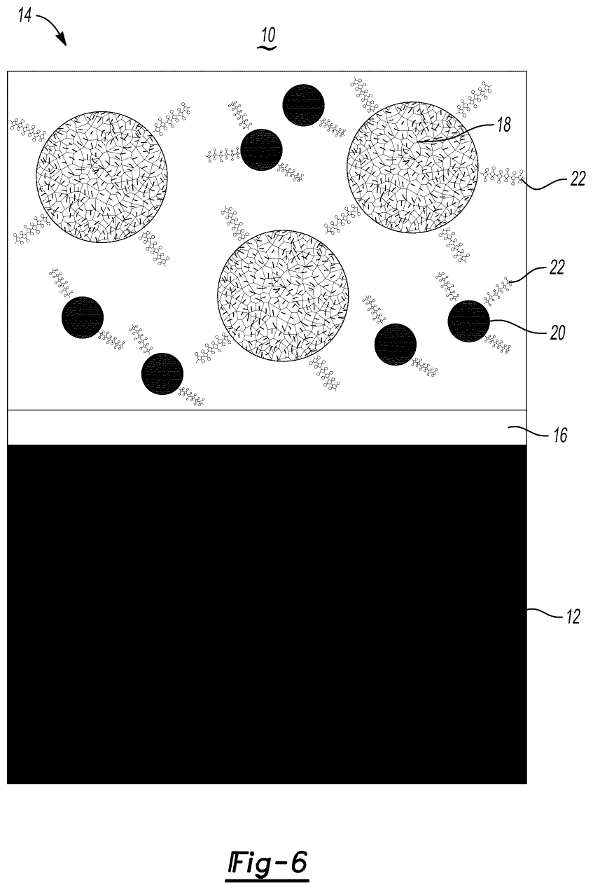

FIG. 6 is a cross-sectional schematic of a lithium-ion battery 10. The lithium-ion battery 10 includes an anode 12, a cathode 14, and a separator 16 positioned between them. The anode 12 serves as the negative electrode and may include materials such as graphite for lithium-ion intercalation during the charging cycle. The separator 16 is a thin, porous membrane that prevents direct contact between the anode 12 and cathode 14, thereby avoiding short circuits while allowing ionic conductivity during charging and discharging.

The cathode 14, serves as the positive electrode, with a composition optimized for electrochemical performance. The cathode 14 contains active material particles 18, which may be lithium metal oxides such as NMC or NCA. These active material particles 18 store and release lithium ions during cycling, facilitating the energy storage function of the battery. Dispersed among the active material particles 18 are CB particles 20, which act as conductive additives to create an electrically percolating network. This network maintains efficient electron transport from the active material particles 18 to a current collector.

Polymer binder particles 22 play a role in the structural and electrochemical functionality of the cathode 14. The polymer binder particles 22, which may include PVDF or other polymers such as PAN or CMC, physically and chemically adhere to the surfaces of the active material particles 18 and CB particles 20. This adhesion maintains mechanical cohesion within the cathode 14 and prevents particle detachment during cycling of the lithium-ion battery 10. The polymer binder particles 22 also minimize inactive regions by achieving coverage, which increases the contact between active materials and the electrolyte, promoting efficient ion transport.

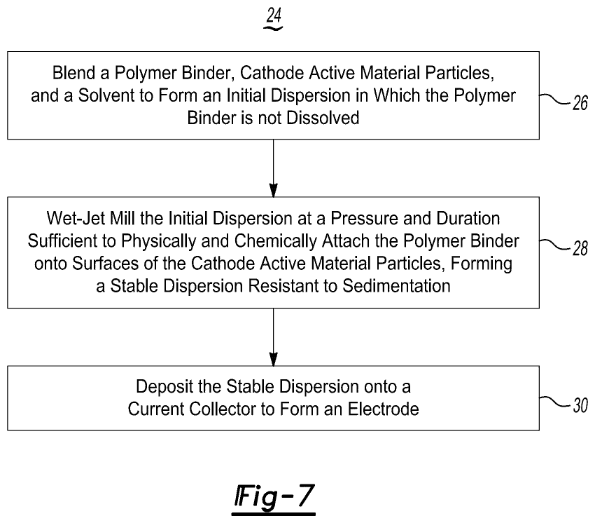

FIG. 7 illustrates a process flow 24 for forming a lithium-ion battery electrode using a novel dispersion method. The process begins with blending a polymer binder, cathode active material particles, and a solvent to form an initial dispersion 26 in which the polymer binder remains undissolved. Unlike conventional methods where the binder is dissolved in the solvent prior to mixing, this approach intentionally leaves the polymer in its undissolved state. The cathode active material particles, such as lithium metal oxides like NMC or LCO, are combined with conductive additives such as CB and a solvent. The solvent, which may include water, alcohols, ketones, or esters, is chosen for compatibility with the active materials. This blending step creates an intentionally unstable dispersion, preparing it for further processing.

The next step involves wet-jet milling the initial dispersion 28. This high-shear process physically and chemically attaches the polymer binder to the surfaces of the cathode active material particles and conductive additives. By applying controlled pressures ranging from 200 bar to 3,000 bar, the wet-jet milling process anchors the polymer chains to the particle surfaces, creating steric hindrance that prevents agglomeration and ensures a uniform dispersion. This step stabilizes the dispersion, making it resistant to sedimentation. Wet-jet milling also allows for control of the polymer coverage, reducing inactive regions and optimizing the electrochemical performance of the electrode. The process parameters are tailored such that the cathode active material particles maintain their structural integrity throughout milling.

In the final step, the stable dispersion is deposited onto a current collector 30 to form the electrode. Typically, the current collector is an aluminum substrate that provides a conductive platform for electron transport. The stable dispersion is applied as a coating and subsequently dried to remove the solvent. After drying, the resulting electrode layer contains a uniform distribution of active material particles, conductive additives, and polymer binder. This uniformity improves the mechanical stability of the electrode while enhancing ionic conductivity and electrochemical performance.

While exemplary embodiments are described above, it is not intended that these embodiments describe all possible forms encompassed by the claims. The words used in the specification are words of description rather than limitation, and it is understood that various changes may be made without departing from the spirit and scope of these disclosed materials.

As previously described, the features of various embodiments may be combined to form further embodiments of the disclosure that may not be explicitly described or illustrated. While various embodiments could have been described as providing advantages or being preferred over other embodiments or prior art implementations with respect to one or more desired characteristics, those of ordinary skill in the art recognize that one or more features or characteristics may be compromised to achieve desired overall system attributes, which depend on the specific application and implementation. These attributes may include, but are not limited to strength, durability, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and may be desirable for particular applications.

What is claimed is:

1. A method of forming an electrode for a lithium-ion battery comprising:
blending a polymer binder, cathode active material particles, and a solvent to form an initial dispersion in which the polymer binder is not dissolved;
wet-jet milling the initial dispersion at a pressure and duration to physically and chemically attach the polymer binder onto surfaces of the cathode active material particles, forming a stable dispersion resistant to sedimentation; and
depositing the stable dispersion onto a current collector to form an electrode.

2. The method of claim 1 wherein the polymer binder is polyvinylidene fluoride.

3. The method of claim 1 wherein the cathode active material particles comprise a lithium metal oxide selected from a group consisting of lithium nickel manganese cobalt oxide, lithium nickel cobalt aluminum oxide, lithium cobalt oxide, lithium manganese oxide, and lithium iron phosphate.

4. The method of claim 1 wherein the solvent is selected from a group consisting of water, alcohols, ketones, esters, ethers, and mixtures thereof, and is substantially free of N-methyl pyrrolidone.

5. The method of claim 1 wherein the wet-jet milling is conducted at a pressure range from 200 bar to 3,000 bar.

6. The method of claim 1 wherein the duration of the wet-jet milling is determined such that, after processing, the stable dispersion exhibits no visible sedimentation for at least one week.

7. The method of claim 1, further comprising controlling parameters of the wet-jet milling to achieve a target level of polymer coverage on the cathode active material particles.

8. The method of claim 1 wherein the stable dispersion exhibits steric hindrance between the cathode active material particles resulting from polymer binder chains adhered to their surfaces.

9. The method of claim 1, further comprising drying the stable dispersion to remove the solvent.

10. A method of forming a lithium-ion battery electrode comprising:
mixing a non-soluble polymer binder, cathode active material particles, and a non-theta solvent to form an initial mixture;
wet-jet milling the initial mixture to form a stable dispersion in which the polymer binder adheres to sterically hindered cathode active material particles; and
adjusting a parameter of the wet-jet milling to generate a predetermined polymer binder loading and form an electrode.

11. The method of claim 10 wherein the parameter is at least one of a pressure, a flow rate, or a milling time.

12. The method of claim 10 wherein the non-theta solvent is ethyl acetate.

13. The method of claim 10 wherein the stable dispersion remains uniform after lithium-ion battery formation.

14. The method of claim 10, further comprising heating the electrode after drying to increase polymer binder adhesion and mechanical integrity.

15. The method of claim 10 wherein the cathode active material particles have a median particle size ranging from 1 μm to 20 μm.

16. The method of claim 10 wherein the polymer binder is selected from a group including polyvinylidene fluoride, polyacrylonitrile, carboxymethyl cellulose, polyimide, and styrene-butadiene rubber.

17. A lithium-ion battery comprising:
an anode;
a cathode, including a stable dispersion of cathode active material particles with surfaces having physically adhered polymer binder molecules in a non-theta solvent to maintain the polymer binder molecules in an undissolved state; and
a separator between the anode and cathode.
